(19) United States
(12) Patent Application Publication
(10) Pub. No.: US 2013/0268601 A1
(43) Pub. Date: Oct. 10, 2013

(54) PLATFORM INDEPENDENT ALERT SYSTEM

(71) Applicant: JAMES P. REILLY, Vancouver, WA (US)

(72) Inventor: JAMES P. REILLY, Vancouver, WA (US)

(21) Appl. No.: 13/439,629

(22) Filed: Apr. 4, 2012

(51) Int. Cl. G06F 15/16

(52) U.S. Cl. 709/206; 709/204

(57) ABSTRACT

Embodiments of the invention describe systems, apparatuses and processes for monitoring one or more sensors associated with one or more physical units in order to generate data associated with the one or more sensors. One or more errors associated with the one or more sensors are identified from the generated data. In response to indentifying said error(s), a message including the error(s) is sent alone with and a web-client with a server stub, wherein the web-client with the server stub is operable to provide a user with an interface for accessing the data associated with the one or more sensors in the one or more physical units. Said interface also allows to user to modify operating parameters associated with the one or more physical units.

### TECHNICAL FIELD

This disclosure relates generally to the field of client and server devices, and in particular but not exclusively, relates to platform independent alert systems for client server devices.

### BACKGROUND

Efficient management and control of physical units in a system (e.g., modular basins in a WasteWater Treatment Plant (WWTP)) requires a quick and accurate assessment of the operational status of the system, requiring significant operator effort, which significantly increases operating and maintenance costs. Current solutions transmit limited data to users, and are often platform-dependent solutions.

What is needed is a platform-independent messaging system that allows users to quickly and efficiently view data related to the operational status of physical units of a system.

### DESCRIPTION OF THE DRAWINGS

Non-limiting and non-exhaustive embodiments of the invention are described with reference to the following figures, wherein like reference numerals refer to like parts throughout the various views unless otherwise specified. It should be appreciated that the following figures may not be drawn to scale.

FIG. 1 is a block diagram of client/server communications according to an embodiment of the invention.

FIG. 2 is a block diagram of a web services architecture according to an embodiment of the invention.

FIG. 3 is a block diagram of client and server modules to exchange message data according to an embodiment of the invention.

FIG. 4A is an illustration of a dynamically configurable and controllable wastewater treatment system utilizing a platform independent alert system according to an embodiment of the invention.

FIG. 4B is an illustration of platform independent alert messages being exchanged by components of the system of FIG. 4A

FIG. 5 is a flow diagram of a process according to an embodiment of the invention.

FIGS. 6A-B are block diagrams of hierarchical displays of physical units in a system based on alert data according to embodiments of the invention.

FIG. 7 is an illustration of image data of a physical unit included in platform independent alert message data according to an embodiment of the invention.

FIG. 8 is an illustration of client/server devices to utilize an embodiment of the invention.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

Embodiments of an apparatus, system and method for a platform independent alert system are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

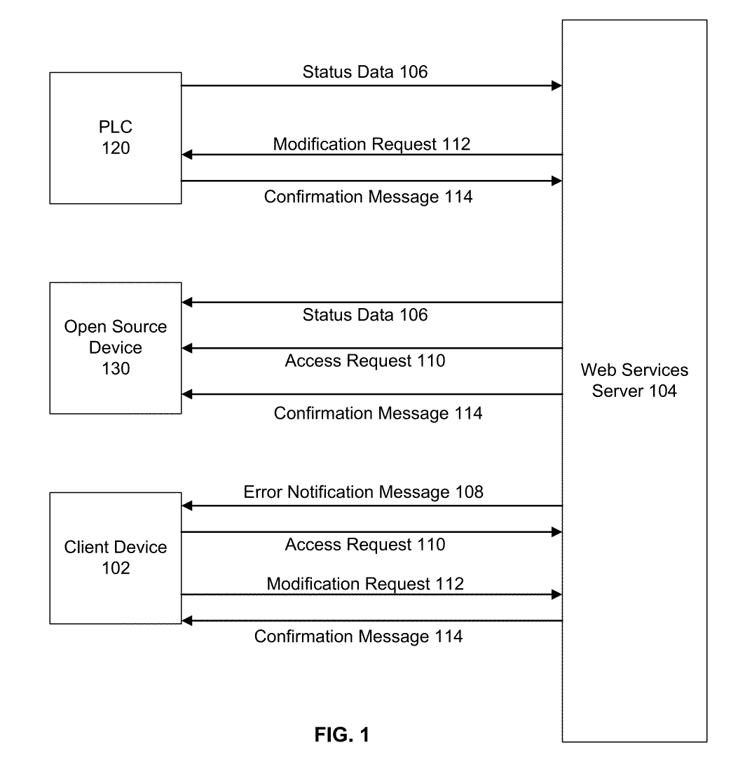

FIG. 1 is a block diagram of client/server communications according to an embodiment of the invention. In this illustrated embodiment, web services server 104 receives data from programmable logic controller (PLC) 120. Said PLC may be used to monitor, program and control operating functions of various physical units (not shown). PLC 120 may by a custom application specific or commercial off the shelf (COTS) controller, and may utilize low-power microprocessors such as ARM or Intel Atom, or microcontrollers such as Arduino or ATMega16. Status data 106 comprises data generated from one or more sensors associated with the one or more physical units. In the event or one more errors associated with the one or more sensors is identified from the generated data, web services server 104 may transmit error notification message/transmission 108 to client device 102 for notifying a user of the client device of the one or more errors. It is to be understood that in some embodiments, said notification may comprise a packetized message of a fixed length, while in other embodiments said error notification may comprise a serialized stream of non-fixed/variable length (e.g., a stream of JSON objects). As used herein, the terms “message” and “transmission” may be used interchangeably without functional deviation when describing embodiments of the invention.

The above described data generated from the one or more sensors may be generated and transmitted such that it comprises data consistent with an eXtensible Markup Language (XML) format, a JavaScript Object Notation (JSON) format, a HyperText Markup Language (HTML) format, and so on. In some embodiments, the format of the transmitted sensor data is selected to represent simple data structures and associative arrays for lightweight text-based human-readable data interchange. For example, the JSON format may be used for serializing and transmitting structured data over a network connection, as this format enables automatic extraction of data.

In this embodiment, open source device 130 comprises an open source database (e.g., POSTGRES, POSTGIS) to receive and update data based on transmissions from PLC 120 and client device 102. Web services server 104 is shown to forward status data 106 to open source device 130 to store as database data accessible to client and server devices via access requests.

Message 106 issued from web services server 104 may include data identifying the one or more errors described above and a web-client with a server stub as described below; because the server stub is transmitted with the web-client in message 106, client device 102 is not required to determine how to invoke the web service to display the relevant error/sensor data. In some embodiments, the web-client with the server stub is operable to provide a user with an interface for accessing the data associated with the one or more sensors in the one or more physical units stored in open source device 130, as illustrated by access request transmission 110.

Said web client/server stubs may also allow the user to modify operating parameters associated with the one or more physical units, shown as transmission 112. PLC 120 may receive and implement the requested modification, and confirm the changes to client device 102, shown as transmission 114. In this embodiment, web services server 104 may also notify open source device 130 of the updated status of the system.

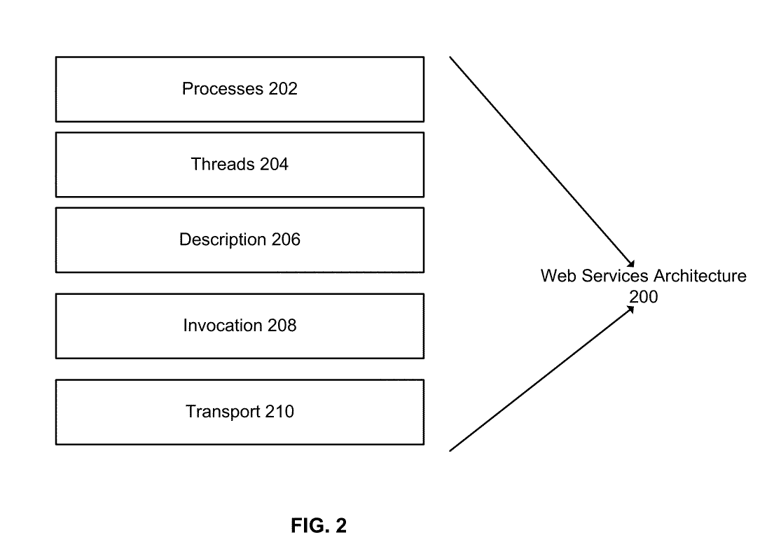

FIG. 2 is a block diagram of a web services architecture according to an embodiment of the invention. Web services architecture 200 may be utilized by the web services server (e.g., server 104 of FIG. 1) to enable a platform independent alert web service according to embodiments of the invention. It is to be understood that web services architectures in various embodiments of the invention may include any combination or subset of the elements described below.

Service processes layer 202 includes various web services available to client devices, including error notification services and diagnostic services. Said process layer may execute one or more threads, shown as element 204. As is known in the art, a thread of execution is the smallest unit of processing that may be scheduled by a host process. Multiple threads may exist within the same process and share resources such as memory, while different processes do not necessarily share these resources. In particular, the threads of a process share the process's instructions (i.e., code) and its context (i.e., values that its variables reference). As described below, embodiments of the invention transport, to a client device, error data in a platform independent manner along with a server stub for accessing said data; for other services, description layer 206 includes information describing what operation each web service supports, and how the client device is to invoke the web service (e.g., diagnostic and/or system management services).

Invocation layer 208 defines how each web service may be invoked by the client device. Invoking web services involves passing messages between the client device and the host web services server. Some formats, such as Simple Object Access Protocol (SOAP) formats, specify schemas for how data sent by the server should be formatted, and how the client device is expected to format its messages.

Transport layer 210 defines the format for messages transmitted between the client device and the web services service. Some embodiments of the invention support HyperText Transfer Protocol (HTTP), such that sensor data may be transmitted and displayed in a manner similar to conventional web pages. Other embodiments of the invention may utilize other protocols (e.g., Short Message Service (SMS) protocol) for transmitting alert and system configuration messages.

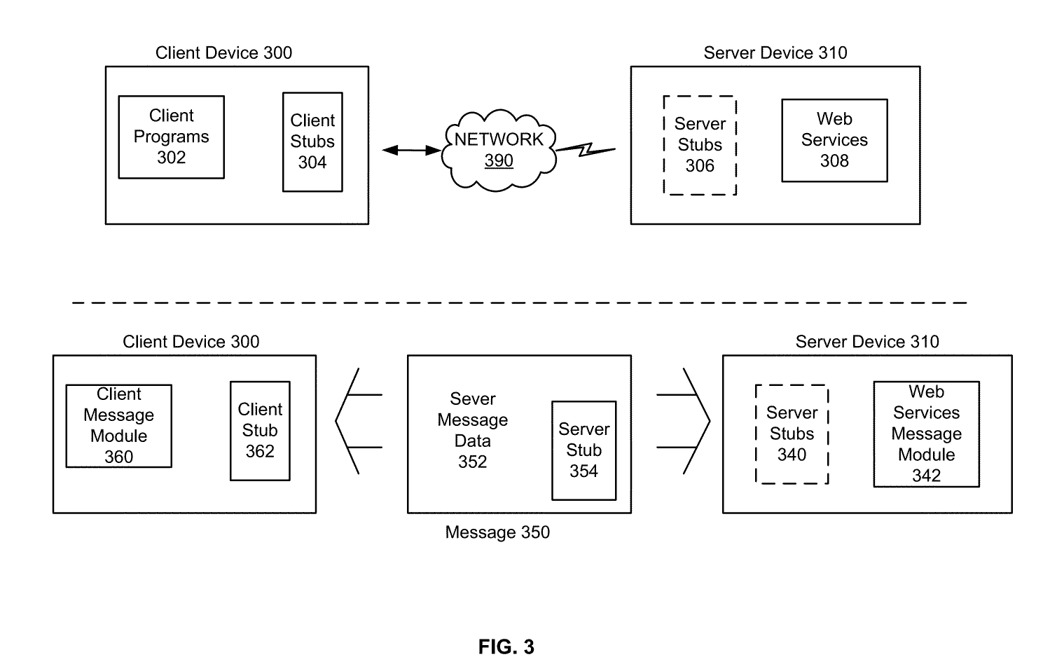

FIG. 3 is a block diagram of client and server modules to exchange message data according to an embodiment of the invention. Client device 300 is illustrated to include client programs 302 and client stubs 304. Server device 310 is shown to include server stubs 306 and web services 308. Client device 300 and server device 310 are shown to be communicatively coupled via network 390 via any of the standard network protocols for the exchange of information. For example, client device 300 may be coupled with network 390 via a wireless connection, such as a cellular telephone connection, wireless fidelity connection, etc. Client device 300 and server device 310 may run on one Local Area Network (LAN) and may be incorporated into the same physical or logical system, or different physical or logical systems. Alternatively, client device 300 and server device 310 may reside on different LANs, wide area networks, cellular telephone networks, etc. that may be coupled together via the Internet but separated by firewalls, routers, and/or other network devices. It should be noted that various other network configurations may be used including, for example, hosted configurations, distributed configurations, centralized configurations, etc.

When client programs 302 seek to invoke web services 308, embodiments of the invention may delegate that task to logic or modules referred to herein as a stub. These stubs, shown as client stubs 304 and sever stubs 306, may be generated once—e.g., during the web services discovery process.

Whenever any of client programs 302 seek to invoke any of web services 308, said client programs access client stubs 304. Said client stubs receive these access requests and convert them into a proper web services request (alternatively referred to as ‘marshalling’ or ‘serializing’). This request is sent over a network (e.g., using the HTTP protocol) and is received, in this illustration, by server stub 306. The server stub converts the request into something web services 308 can understand (alternatively referred to herein as ‘unmarshalling’ or ‘deserializing’).

Once the request has been deserialized, the server stub invokes the service implementation, which then carries out tasks related to the client request. The results of the requested operation are handed to server stubs 308, which turn it into a response to be received by client stubs 306. Said client stubs covert the response from the server stubs into something client applications 302 may understand, so that said applications may receive the result of the Web Service invocation and use it.

Message 350 illustrates that embodiments of the invention transmit server message data 352 (e.g., sensor and/or error data as described herein) along with server stub 354 for invoking a web service related to displaying or presenting said data to any client or server device. Thus, the above described marshalling/unmarshalling of requests is capable of occurring on client device 300 or server device 310 via the received server stub. Therefore, the message display is displayed no matter what client message module 362 is—e.g., client message module 362 (and client stub 364) may comprise an email application, a web browsing application, a proprietary application, etc. Similarly, message data 352 is capable of being opened by server device 310 regardless of whether the appropriate server stub is included in server stubs 340 i.e., the message data may be accessed via received server stub 354.

In the following description, embodiments of the invention are shown to be utilized in the context of WasteWater Treatment Plants (WWTPs) utilized to process and purify water from industrial operations and municipal sources; it is to be understood embodiments of the invention may be executed in various other contexts, and the following description is not to limit embodiments of the invention to a specific use.

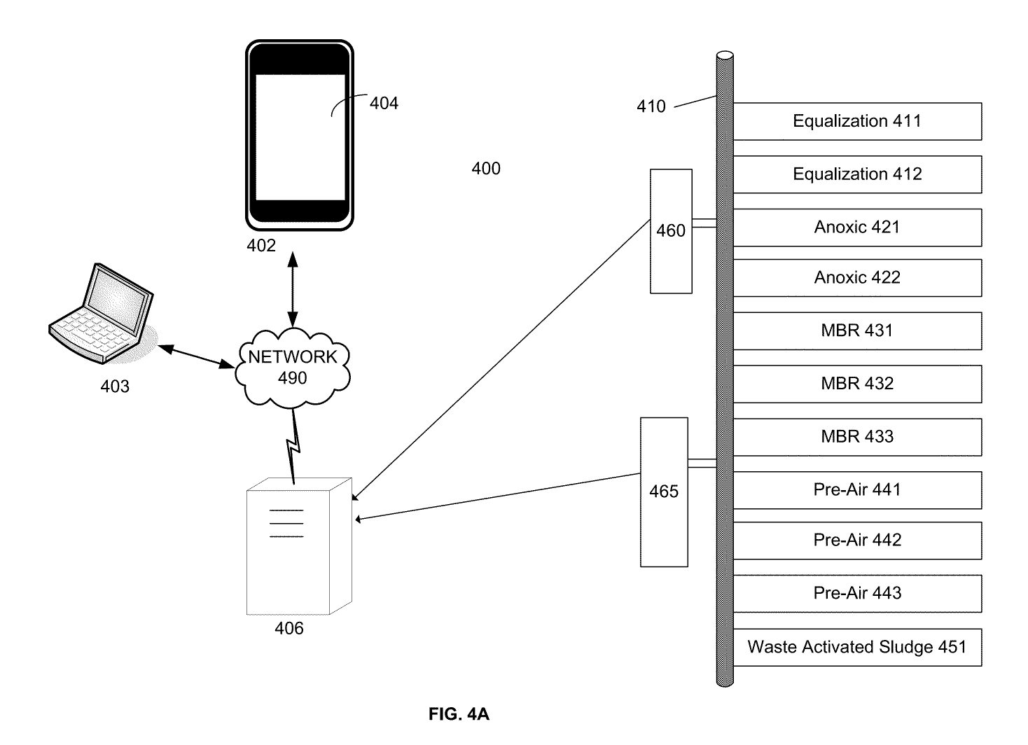

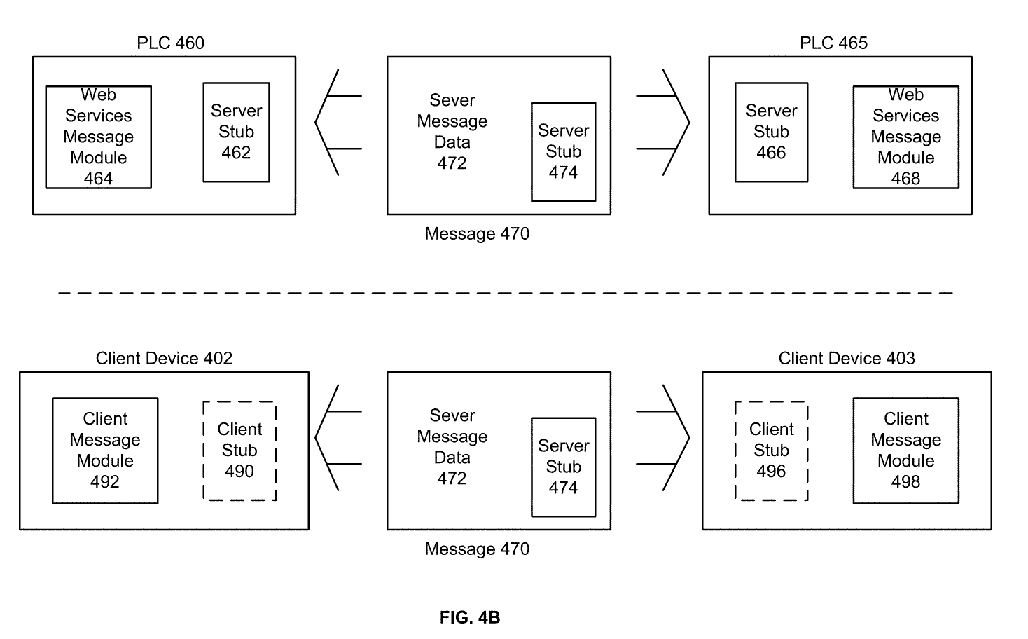

FIG. 4A is an illustration of a dynamically configurable and controllable wastewater treatment system utilizing a platform independent alert system according to an embodiment of the invention. In this embodiment, system 400 is illustrated as a plurality of modular wastewater treatment subsystems, each executing a specific wastewater treatment function. Wastewater is routed through the various wastewater treatment subsystems via routing subsystem 410, in any order as necessary.

For the sake of clarity, the various components of wastewater treatment system 400 are illustrated and described as a plurality of online/offline modular basins/containers operatively coupled to form a dynamically configurable capacity.

In this embodiment, system 400 includes equalization basins 411 and 412, which receive wastewater from an influent source (e.g., a collection system). Equalization basins handle variations in flows from the influent source so that other wastewater treatment components may be configured to handle “average” flows, rather than “peak” flows. Using modular basins, the effort and cost associated with adding additional equalization basins (i.e., equalization capacity) to system 400 in order to attenuate larger peak flows is minimal compared to prior art solutions.

System 400 further includes anoxic basins 421 and 422. When anoxic conditions are desired, said anoxic basins may divert air away from wastewater influent in order to execute an anoxic process (e.g., de-nitrification of nitrates and nitrites). It is understood that air need not be completely diverted when executing certain anoxic processes. For example, a minimum amount of air may be desired to assist in an anoxic process, so long as the air present under anoxic basins 421 and 422 is not sufficient to support aerobic conditions. The anoxic process may be, for example, thermophilic digestion, in which sludge is fermented in tanks at a temperature of 45° C., or mesophilic, at a temperature of around 36° C.

In one embodiment, a mixer is included in anoxic basins 421 and 422 to maintain solids in the wastewater influent in suspension. Said basins may further include a submersible feed-forward pump to control the flow out of the basin to downstream aeration basins (described below) to maintain internal recycle (e.g., 4 times the system influent flow). A submersible waste activated sludge pump may further control the wasting of solids from anoxic basins 421 and 422 to waste activated sludge basins (described below) in order to maintain a desired mixed liquor suspended solids concentration (MLSS).

System 400 further includes membrane bioreactor (MBR) basins 431, 432 and 433. MBRs are used in wastewater treatment systems to improve activated sludge wastewater treatment processes, combining bio-reactive treatment processes with membrane separation processes. MBR basins 431-433 use membranes to separate and concentrate the biomass by removing wastewater (as opposed to using settling processes). Furthermore, said MBR basins may retain particulate matter, remove a high percentage of pathogens, and remove dissolved materials from the wastewater influent.

Membranes utilized by said MBR basins may be of any material (e.g., synthetic or natural) or porosity determined based on system requirements (e.g., quality requirements of the effluent). For example, MBR basins 431-433 may utilize reverse osmosis, nanofiltration, ultrafiltration, microfiltration, or any other solid/liquid separation membranes known in the art. Said membranes may be of any configuration suitable for system 400 (e.g., sheet, hollow tube). In one embodiment, wastewater processed from MBR basins 431-433 is recycled back to anoxic basins 421 and 422. Centrifugal permeate pumps may further strain permeate from the wastewater, and transfer the permeate downstream to a ultra-violet disinfection system (not shown) to discharge.

System 400 further includes aeration (i.e., pre-air) basins 441, 442 and 443 to deliver a suitable amount of air into the wastewater influent to promote aerobic reactions (e.g., a reaction taking place in the presence of oxygen) within the basins via, for example, air bubbles, compressed air streams, or any means to inject air into the wastewater influent. The contents of aeration basins 441-443 may be aerated and mixed to reduce the amount of time required for the aerobic reaction to occur and to reduce the level of foul odors produced by the reaction. The waste activated sludge (WAS) produced by aeration basins 441-443 may be received by WAS basin 451 for processing.

WAS basin 451 may execute any solids processing means known in the art. In one embodiment, WAS basin 451 is equipped with coarse bubble aeration fed from aeration blowers to prevent the wastewater in the basin from turning anaerobic and emitting unpleasant odors.

In some embodiments of the invention, a wastewater treatment modular basin may execute a plurality of wastewater treatment processes, and a wastewater treatment system may comprise a redundant array of modular basins. Said basins may be brought online or offline, as described above, in order to increase a capacity of the host wastewater treatment system, or to change the quality of the wastewater effluent.

In some embodiments of the invention, to use less space and to treat difficult waste and intermittent flows, a number of designs of hybrid wastewater treatment containers may be utilized. For example, such container may combine at least two wastewater treatment stages into one combined stage. For example, one type of system that combines secondary treatment and settlement is a sequencing batch reactor (SBR). Typically, activated sludge is mixed with raw incoming sewage, and then mixed and aerated. The settled sludge is run off and re-aerated before a portion is returned to the headworks. The disadvantage of the SBR process is that it requires a precise control of timing, mixing and aeration. This precision is typically achieved with computer controls linked to sensors. Such a complex, fragile system is not ideal for places where controls may be unreliable, poorly maintained, or where the power supply may be intermittent. In a multi-container configuration (i.e., a system utilizing standalone wastewater treatment containers) each container may handle influent separately and if any individual container has a failure, on the detection of the failure the contents of the container could be rerouted to an alternative (and fully functional) container to compete its processing.

PLCs 460 and 465 may interface with control sensors monitoring the operating conditions of the basins of system 400, and may transmit sensor data to computer system server system 406 for processing. PLCs 460 and 465 may work in tandem, independently, redundantly (i.e., in case one of the PLCs experiences an operation failure), etc. Server system 406 may be communicatively coupled with client devices 402 & 403 via network 490 to send platform independent alerts based on said sensor data for said client device to display (e.g., via display 404). Said client devices may a comprise personal computer, laptop, tablet computer, smartphone, etc. Said server system 406 may further include web services for managing the operation of system 400, bring certain modular wastewater treatment basins online or offline, re-route wastewater influent dynamically based on updates to the configuration of the basins, etc.

FIG. 4B is an illustration platform independent alert messages being exchanged by components of the system of FIG. 4A. PLC 460 is shown to include web services message module 464 and server stub 462, while PLC 465 is shown to include web services message module 468 and server stub 466. Client device 402 is shown to include client message module 492 and client stub 490, while client device 403 is shown to include client message module 498 and client stub 496.

As described above in FIG. 3, message 470 including message data 472 and server stub 474 may be exchanged between any client device and any service device; FIG. 4B further illustrates that message 470 may be exchanged between two client devices (i.e., client devices 402 and 403) and two server devices (shown here to be PLCs 460 and 465) regardless of whether the appropriate server stub is included in the receiving device. This allows for a uniform format to be utilized by each device regardless of its software or hardware configuration—i.e., the format of message data 472 and the inclusion of server stub 474 allow message 470 to be opened in some form regardless of the hardware/software platform of the transmitting/receiving client or server device, thereby enabling any device receiving message 470 to act as a “server manager” of the physical unit related to message data 472.

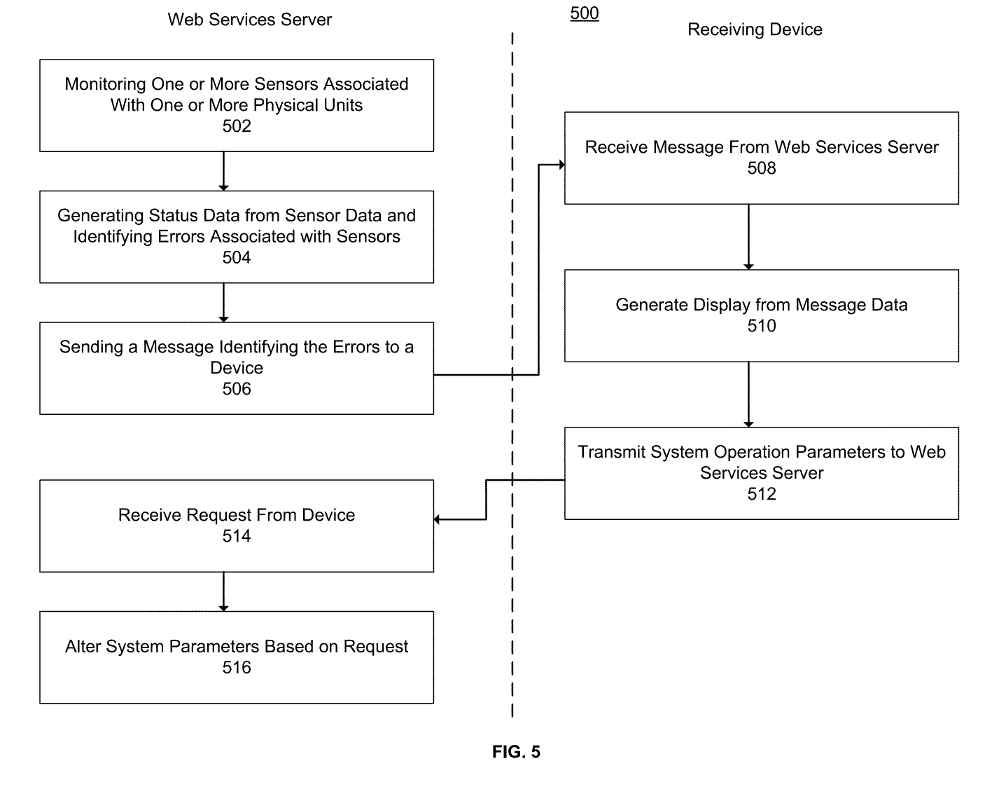

FIG. 5 is a flow diagram of a process according to an embodiment of the invention. Flow diagrams as illustrated herein provide examples of sequences of various process actions. Although shown in a particular sequence or order, unless otherwise specified, the order of the actions can be modified. Thus, the illustrated implementations should be understood only as examples, and the illustrated processes can be performed in a different order, and some actions may be performed in parallel. Additionally, one or more actions can be omitted in various embodiments of the invention; thus, not all actions are required in every implementation. Other process flows are possible.

Process 500 includes operations, executed by a web services server, for monitoring one or more sensors associated with one or more physical units, 502. In the context of WWTP management, said sensors may include water-level sensors, temperature sensors, turbidity sensors, pressure sensors and the like to monitor a water level in the one or more physical units, an operating temperature, an air blower speed, filter functionality, etc.

System status data is generated from said sensor data, and one or more errors are identified, 504. A message including the one or more errors is sent to a receiving device (e.g., client or server device), 506. In some embodiments, said message includes a web-client with a server stub, operable to provide a user of the device with an interface for accessing the data associated with the one or more sensors in the one or more physical units. In some embodiments of the invention, the message includes a hyper-link to the sensor data, a time snapshot of system data corresponding to the one or more errors, and/or a time snapshot of the data corresponding to the one or more physical units with no errors.

Said device receives the message from the server, 508, and generates a display of the message data, 510. Said display may include an image of the one or more physical units for indicating the one or more errors associated with the one or more sensors, a three-dimensional (3D) animation of the one or more physical units including the errors, as hierarchical display of the system, and so-on. Data access and subsequent message transmission to the server may be executed via the server stub.

Said device may transmit a request for modifying operating parameters associated with the one or more physical units, 512. Upon receiving the request from the device, 514, the server device modifying operating parameters of the system (e.g., for WWTP management, bring certain modular wastewater treatment basins online or offline, re-route wastewater influent dynamically based on updates to the configuration of the basins, etc.), 516.

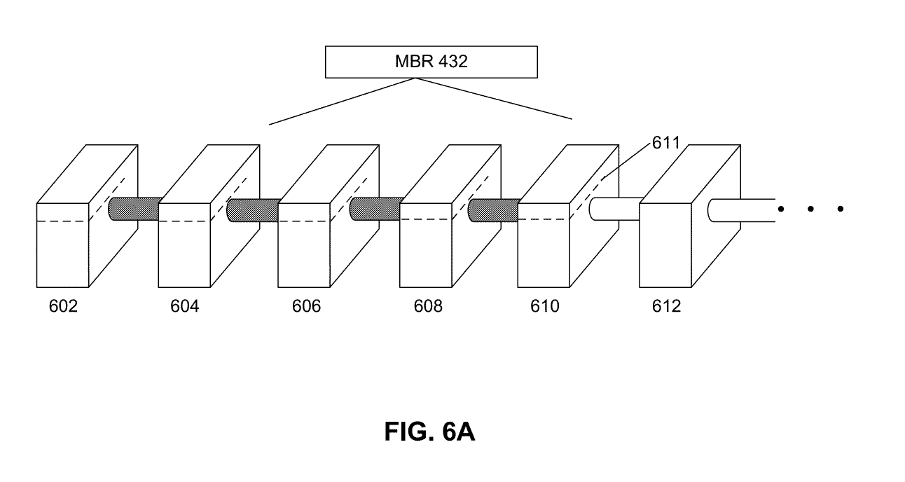

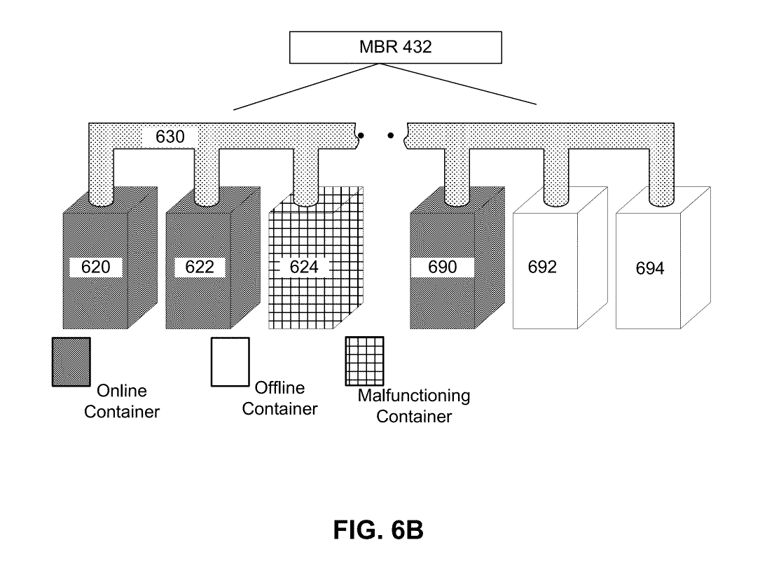

FIGS. 6A-B are block diagrams of hierarchical displays of physical units in a system based on alert data according to embodiments of the invention. In the illustrated embodiment of FIG. 6A, MBR subsystem 432 (of FIG. 4) is shown to include a plurality of containers 602, 604, 606, 608, 610 and 612. In this embodiment, said containers are coupled in series and act in concert to perform the same wastewater management function. In other embodiments, said containers may each perform a separate function (e.g., some containers may function as an aeration tank while others containers may function as a membrane basin), or may each perform a plurality of functions.

In the illustrated embodiment, containers 602-610 are shown as being in an “online” state—i.e., containers 602-610 are “online” to receive wastewater input flow. Container 612 is shown as being in an “offline” state—i.e., configured so that it cannot receive wastewater input flow.

In this embodiment, each of the containers 602-610 includes a high water-mark (e.g., mark 611 of basin 610), to indicate that the wastewater input flow for the respective basin is higher than a “threshold level,” which may represent, for example, the capacity of the basin, and “ideal” volume for the basin, etc. In other embodiments, a basin may also include a low-water mark to indicate that the wastewater input flow for the respective basin is lower than an operating capacity for the basin, lower than an “ideal” volume for the basin, etc.

In this example, sensors may detect that each of basins contains a volume of wastewater that exceeds its respective watermark. Embodiments of the invention send platform independent alert messages to a client device as described above. Said message may include a graphical representation of, for example, the entire system (e.g., the block diagram of the WWTP system as shown in FIG. 4), and highlight the fact that MBR subsystem 432 is malfunctioning. Said client device may issue requests to view individual components of MBR subsystem 432, may configure the capacity of sub-system in response to any system level event or operating parameter that may require the operational capacity of sub-system to be increased, such as a significant increase in input flow, changes to the input/output water quality of the sub-system, a determination that at least one of online containers 602-610 is malfunctioning, overflow/underflow conditions, etc.

In the illustrated embodiment of FIG. 6B, MBR subsystem 432 (of FIG. 4) is shown to include a plurality of containers 620, 622, 624 . . . 690, 692 and 694. Said basins perform the same function (or functions) and are coupled in parallel—i.e., each of the basins receives wastewater input in parallel from inlet 630. This configuration allows for parallel processing of the wastewater input, as well as a relatively short water path.

Embodiments of the invention send platform independent alert messages to a client device as described above. Said message may include a graphical representation of, for example, the entire system (e.g., the block diagram of the WWTP system as shown in FIG. 4), and highlight the fact that MBR subsystem 432 is malfunctioning. Said client device may issue requests to view individual components of MBR subsystem 432. In this example, it is shown that container 624 is malfunctioning. The user of the client device may further request additional graphical and error data for container 624, may configure the capacity of sub-system in response to any system level event or operating parameter that may require the operational capacity of sub-system to be increased (i.e., bring any of offline containers 692 and 694 online), such as a significant increase in input flow, changes to the input/output water quality of the sub-system, etc.

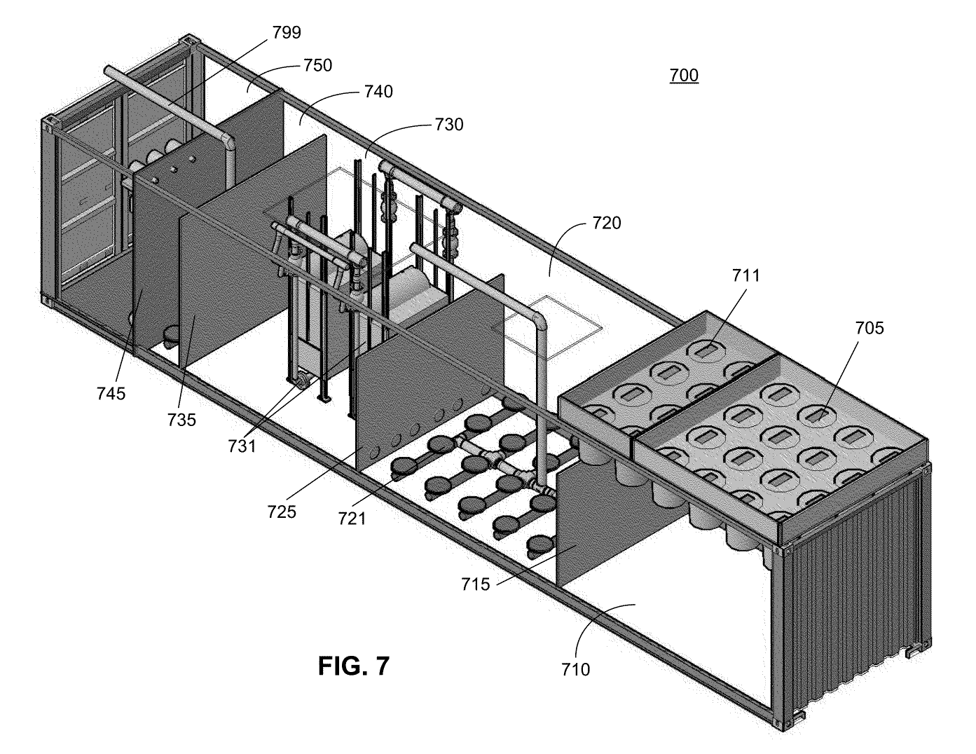

FIG. 7 is an illustration of image data of a physical unit included in platform independent alert message data according to an embodiment of the invention. In this embodiment, modular basin 700 includes a plurality of wastewater treatment compartments, each executing a specific wastewater treatment function. Message data described above may include the described illustration, and highlight or indicate malfunctioning areas of basin 700—e.g., 3D animation data illustrating wastewater influent processed through the various components of basin 700.

In this embodiment, modular basin 700 receives wastewater from an influent source (e.g., a collection system) via headworks pipes 705 into anoxic compartment 710. In some embodiments, at the start of the wastewater purification process there is a requirement to remove all solids larger than a threshold value (e.g., 2 mm in diameter). This phase of treatment may be referred to as “headworks” processing. This processing may be executed in a standalone wastewater treatment container, or incorporated in a multi-function wastewater treatment container.

When anoxic conditions are desired, anoxic compartment 710 may divert air away from the wastewater influent via outlet 711 in order to execute an anoxic process (e.g., de-nitrification of nitrates and nitrites). Modular basin 700 further includes weir 715 disposed between anoxic compartment 710 and aeration compartment 720 (described below). In order for modular basin 700 to execute a plurality of wastewater treatment functions, certain water levels may be maintained in various wastewater treatment processing compartments. It is also desirable to take advantage of “gravity flow” in order to reduce the number of mechanical pumps necessary to move water within the modular basin. Weir 715 may be utilized in embodiments of the invention to address this problem. In one embodiment, weir 715 is an overflow barrier that forms a controlled waterfall to alter the flow characteristics of wastewater transferred from anoxic compartment 710 to aeration compartment 720. In another embodiment, weir 715 is a modified pipe-weir. Said weir may be affixed to one of the interior walls of modular basin 700, and may be lower in height or perforated with holes at the desired water level.

In the illustrated example embodiment, once anoxic compartment 710 is filled, the water overflows into adjacent aeration compartment 720 via weir 715. The wastewater remains at the weir wall height in anoxic compartment 710 in perpetuity, while the water level in aeration compartment 720 fluctuates as a function of the water coming into the anoxic compartment (i.e., wastewater received at input 705 of modular wastewater container 700).

Modular basin 700 further includes aeration (i.e., pre-air) compartment 720 to deliver a suitable amount of air into the wastewater influent received from anoxic compartment 710 to promote aerobic reactions (e.g., a reaction taking place in the presence of oxygen) within the basin via, for example, air bubbles, compressed air streams, or any means to inject air into the wastewater influent. Said aerobic reaction may reduce the biochemical oxygen demand (BOD) and may further nitrify ammonia present in the wastewater influent to nitrate.

In this embodiment, aeration compartment 720 utilizes a mixer and coarse aeration bubble diffusers; aeration is supplied to aeration compartment 720 via positive displacement aeration pumps 721 to pump pipe air to the diffusers.

Weir 725 controls the flow of wastewater influent from aeration compartment 720 to MBR compartment 730. Weir 725 may comprise any embodiment similar to that of weir 715.

MBR compartment 730 executes both bio-reactive treatment processes with membrane separation processes. MBR compartment 730 uses membranes to separate and concentrate the biomass by removing wastewater (as opposed to using settling processes). Furthermore, said MBR compartment may retain particulate matter, remove a high percentage of pathogens, and remove dissolved materials from the wastewater influent.

Membranes utilized by MBR compartment 730 may be of any material (e.g., synthetic or natural) or porosity determined based on system requirements (e.g., quality requirements of the effluent). For example, said MBR compartment may utilize reverse osmosis, nanofiltration, ultrafiltration, microfiltration, or any other solid/liquid separation membranes known in the art. Said membranes may be of any configuration suitable for modular basin 700 (e.g., sheet, hollow tube). In one embodiment, MBR compartment 730 utilizes polypropylene membrane filters comprising 0.4 micrometer pores.

In this embodiment, MBR compartment 730 includes air blowers 731 to provide aeration to the compartment to reduce BOD, convert ammonia to nitrate, and provide air scour to reduce fouling. Sodium hypochlorite may be pumped through the membranes of the compartment to prevent fouling of the membrane filters, and aluminum and magnesium sulfate may be fed into the MBR compartment to neutralize the pH levels of the wastewater influent.

Weir 735 controls the flow of wastewater influent from MBR compartment 730 to WAS compartment 740. Weir 735 may comprise any embodiment similar to that of weirs 715 and 725.

WAS compartment 740 may execute any solids processing means known in the art. In one embodiment, pipe 741 transfers WAS from basin 700 for further processing (e.g., disposal, solids discharging, etc.) via effluent pipe 799.

Control compartment 750 may monitor the operation conditions of the various compartments of basin 700, and may collect and transmit sensor data, manage the operation of the basin, bring the basin online or offline, etc. In this embodiment, liner wall 745 separates control compartment 750 from the wastewater treatment compartments described above.

The modular wastewater treatment basins described above allow for automated WWTP system planning and construction. Each individual basin may be uniformly constructed, stackable, and operable, enabling multiple WWTP system sites to have the same basin configurations, the same hardware, the same power and piping configurations, etc. Thus, a WWTP system site may be planned and designed based on a minimum amount of operating parameters.

As described above, in some embodiments of the invention a modular wastewater treatment container is to include a plurality of basins. Said containers may utilize weirs to form these basins (alternatively referred to herein as “basin components.”) In order for a modular wastewater treatment container to include a plurality of basin compartments that separately perform a wastewater treatment function, certain water levels should be maintained in the various compartments. It is also desirable to take advantage of “gravity flow” in order to reduce the number of mechanical pumps necessary to move water around within the modular wastewater treatment container.

In this embodiment, intermodal container 700 is consistent with any International Organization for Standardization (ISO) specification for intermodal containers (e.g., Technical Specification for Steel Dry Cargo Container, Spec. No. ITRU-40′-SA, Jun. 12, 2001)—e.g., container 700 may be a steel dry cargo container ISO IAA type 40′×8′×8′6″ or 20′×8′×8′6″. In this embodiment, the interior of container 100 a basin (and thus, the terms “container” and “basin” is used interchangeably herein to describe a similar structure); in other embodiments, a wastewater treatment basin may be included in container 700, but said basin's shape and volume may be independent of the dimensions of container 700.

Lining portions of the interior of container 700 with a corrosion resistant liner may form a basin to hold wastewater process material. In this embodiment, basin 700 is formed by lining the interior of container 700 with a corrosive resistant liner, which may comprise at least one layer of polyvinyl chloride (PVC), Low Density Polyethylene (LDPE) or High Density Polyethylene (HDPE) liner. It is to be understood that utilizing an ISO container and said liner material to construct a wastewater treatment basin significantly reduces the costs of said basin compared to materials used in the prior art (e.g., concrete and stainless steel).

Container 700 enables a modular design approach for a wastewater treatment plant (WWTP) by subdividing said systems into smaller parts which may be easily manufactured and transported. For example, in the event increased capacity is desired, additional containers may be inexpensively added to meet the demand. Furthermore, WWTP components according to embodiments of the invention may be independently created and replaced, thereby reducing the labor and costs associated with lifetime maintenance of a WWTP.

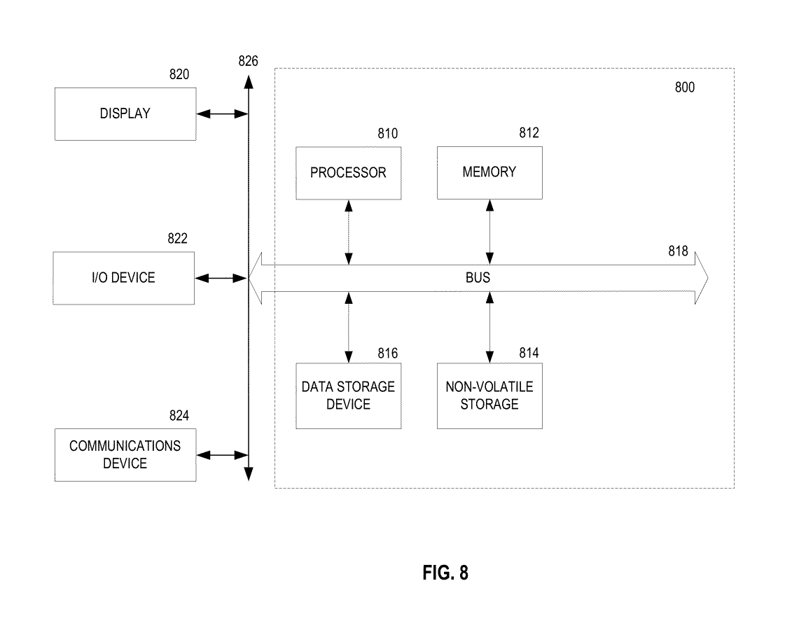

FIG. 8 is an illustration of client/server devices to utilize an embodiment of the invention. System 800 as illustrated may be any of the client and server devices described above. As illustrated, system 800 includes bus communication means 818 for communicating information, and processor 810 coupled to bus 818 for processing information. The system further comprises volatile storage memory 812 (alternatively referred to herein as main memory), coupled to bus 818 for storing information and instructions to be executed by processor 810. Main memory 812 also may be used for storing temporary variables or other intermediate information during execution of instructions by processor 710. The system also comprises static storage device 816 coupled to bus 818 for storing static information and instructions for processor 810, and data storage device 814 such as a magnetic disk or optical disk and its corresponding disk drive. Data storage device 814 is coupled to bus 818 for storing information and instructions.

The system may further be coupled to display device 820, such as a cathode ray tube (CRT) or a liquid crystal display (LCD) coupled to bus 818 through bus 826 for displaying information to a computer user. I/O device 822 may also be coupled to bus 818 through bus 826 for communicating information and command selections (e.g., alphanumeric data and/or cursor control information) to processor 810.

Another device, which may optionally be coupled to computer system 800, is a communication device 824 for accessing other nodes of a distributed system via a network in order to transmit platform independent alert messages as described above. Communication device 824 may include any of a number of commercially available networking peripheral devices such as those used for coupling to an Ethernet, token ring, Internet, or wide area network. Communication device 824 may further be a null-modem connection, or any other mechanism that provides connectivity between computer system 800 and other devices. Note that any or all of the components of this system illustrated in FIG. 8 and associated hardware may be used in various embodiments of the invention.

It will be appreciated by those of ordinary skill in the art that any configuration of the system may be used for various purposes according to the particular implementation. The control logic or software implementing embodiments of the invention can be stored in main memory 812, mass storage device 814, or other storage medium locally or remotely accessible to processor 810.

It will be apparent to those of ordinary skill in the art that the system, method, and process described herein can be implemented as software stored in main memory 812 or read only memory 816 and executed by processor 810. This control logic or software may also be resident on an article of manufacture comprising a computer readable medium having computer readable program code embodied therein and being readable the mass storage device 814 and for causing processor 810 to operate in accordance with the methods and teachings herein.

Various components referred to above as processes, servers, or tools described herein may be a means for performing the functions described. Each component described herein includes software or hardware, or a combination of these. Each and all components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration) may be provided via an article of manufacture including a non-transitory, tangible computer or machine readable storage medium, which provides content that represents instructions that can be executed. The content may result in a computer performing various functions/operations described herein.

A computer readable non-transitory storage medium includes any mechanism that provides (i.e., stores and/or transmits) information in a form accessible by a computer (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer readable non-transitory storage medium may also include a storage or database from which content can be downloaded. Said computer readable medium may also include a device or product having content stored thereon at a time of sale or delivery. Thus, delivering a device with stored content, or offering content for download over a communication medium may be understood as providing an article of manufacture with such content described herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A machine-readable storage medium having computer executable instructions stored thereon that, when executed, cause a processor to perform a method comprising:
monitoring one or more sensors associated with one or more physical units, the monitoring to generate data associated with the one or more sensors;
identifying, from the generated data, one or more errors associated with the one or more sensors; and
sending a message including the one or more errors and a web-client with a server stub, wherein the web-client with the server stub is operable to provide a user with an interface for accessing the data associated with the one or more sensors in the one or more physical units, and modifying operating parameters associated with the one or more physical units.

2. The machine-readable storage medium of claim 1, the method further comprising:
generating an image of the one or more physical units, the image indicating the one or more errors associated with the one or more sensors.

3. The machine-readable storage medium of claim 2, wherein the image is a three dimensional (3D) animation indicating a visual of the one or more errors.

4. The machine-readable storage medium of claim 2, wherein the message includes at least one or more of:
a hyper-link to the image,
the image;
a time snapshot of the data corresponding to the one or more errors; or
a time snapshot of the data corresponding to the one or more physical units with no errors.

5. The machine-readable storage medium of claim 1, wherein the one or more physical units comprise one or more Waste Water Treatment Plant (WWTP) containers and the operating parameters comprise at least one of:
a water level in the one or more physical units;
an air blower speed to the one or more physical units; or
a power supply level to the one or more physical units.

6. The machine-readable storage medium of claim 5, wherein the one or more sensors include at least one of:
level-sensors;
temperature sensors;
turbidity sensors; and
pressure sensors.

7. The machine-readable storage medium of claim 1, the method further comprising:
receiving a request from a client; and
sending, to the client in respond to receiving the request, a name of a data file associated with the data generated by monitoring.

8. The machine-readable storage medium of claim 1, wherein sending the message comprises:
sending an email or a Short Message Service (SMS) message to a queue;
extracting the email or the SMS message from the queue after waiting for a random time limit; and
sending the extracted email or the SMS message to a client.

9. The machine-readable storage medium of claim 1, the method further comprising:
classifying the one or more errors by one or more error types prior to sending the message.

10. The machine-readable storage medium of claim 1, wherein the message is an operating system independent message.

11. The machine-readable storage medium of claim 1, wherein identifying, from the generated data, one or more errors associated with the one or more sensors comprises determining whether the data crossed a threshold level associated with the one or more sensors.

12. A system comprising:
a processor;
a memory;
communication logic for communicatively coupling the system to one or more physical units and a client device; and
logic to:
monitor one or more sensors associated with the one or more physical units, the monitoring to generate data associated with the one or more sensors;
identify, from the generated data, one or more errors associated with the one or more sensors; and
send a message including the one or more errors and a web-client with a server stub to the client device, wherein the web-client with the server stub is operable to provide a user with an interface for accessing the data associated with the one or more sensors in the one or more physical units, and modifying operating parameters associated with the one or more physical units.

13. The system of claim 12, the logic to further:
generate an image of the one or more physical units, the image indicating the one or more errors associated with the one or more sensors.

14. The system of claim 13, wherein the image is a three dimensional (3D) animation indicating a visual of the one or more errors.

15. The system of claim 12, wherein the message includes at least one or more of:
a hyper-link to the image,
the image;
a time snapshot of the data corresponding to the one or more errors; or
a time snapshot of the data corresponding to the one or more physical units with no errors.

16. The system of claim 12, wherein the one or more physical units comprise one or more Waste Water Treatment Plant (WWTP) containers and the operating parameters comprise at least one of:
a water level in the one or more physical units;
an air blower speed to the one or more physical units; or
a power supply level to the one or more physical units.

17. The system of claim 16, wherein the one or more sensors include at least one of:
level-sensors;
temperature sensors;
turbidity sensors; and
pressure sensors.

18. The system of claim 12, the logic to further:
receive a request from the client device; and
send, to the client device in respond to receiving the request, a name of a data file associated with the data generated by monitoring.

19. The system of claim 12, wherein sending the message comprises:
sending an email or a Short Message Service (SMS) message to a queue;
extracting the email or the SMS message from the queue after waiting for a random time limit; and
sending the extracted email or the SMS message to a client.

20. The system of claim 12, the logic to further:
classify the one or more errors by one or more error types prior to sending the message.

21. The system of claim 12, wherein the message is an operating system independent message.

22. The system of claim 12, wherein identifying, from the generated data, one or more errors associated with the one or more sensors comprises determining whether the data crossed a threshold level associated with the one or more sensors.
